(19) United States
(12) Patent Application Publication
(10) Pub. No.: US 2018/0011666 A1
(43) Pub. Date: Jan. 11, 2018

(54) IMAGE PRINTING SYSTEM, IMAGE PRINTING METHOD, AND PAYMENT MACHINE

(71) Applicant: Dai Nippon Printing Co., Ltd., Tokyo (JP)

(72) Inventor: Jun YOSHIDA, Tokyo (JP)

(73) Assignee: Dai Nippon Printing Co., Ltd., Tokyo (JP)

(21) Appl. No.: 15/546,105

(22) PCT Filed: Jan. 27, 2016
(86) PCT No.: PCT/JP2016/052298

§ 371 Date: Sep. 18, 2017

(30) Foreign Application Priority Data
Jan. 27, 2015 (JP) 2015-013377

(51) Int. Cl. G06F 3/12; G06Q 20/04; G06Q 20/20; H04N 1/32; H04N 1/00; G06Q 20/18; H04N 1/34; G06K 19/06

(52) U.S. Cl. CPC G06F 3/1204; H04N 1/00334; G06Q 20/045; G06Q 20/18; G06Q 20/209; H04N 1/32122; G06K 19/06028; H04N 1/346; H04N 2201/3202; H04N 2201/3269

(57) ABSTRACT

An image printing system includes a plurality of image printing apparatuses each configured to accept a print order and print the image data, a payment machine performing a billing process, and a ticketing machine. If payment at the payment machine is selected, the image printing apparatus issues a first ticket and transmits order details to the payment machine. If payment at a counter is selected, the image printing apparatus 1 transmits second key information to the ticketing machine. After performing a billing process, the payment machine issues a third ticket on which first key information is printed and transmits the first key information to the image printing apparatus. The ticketing machine issues a fourth ticket including the second key information. The image printing apparatus prints the image data if accepting input of the key information printed on the third ticket or the fourth ticket.

### TECHNICAL FIELD

The present invention relates to an image printing system that prints image data stored in a medium owned by the user, an image printing method, and a payment machine.

### BACKGROUND ART

Image printing apparatuses that read and print out digital data of images taken by digital cameras, smartphones, and the like are installed in various locations. For example, the user brings in a storage medium storing image data captured by a digital camera, and makes the image printing apparatus read the image data in the storage medium. The image printing apparatus displays images of the image data read from the storage medium, and presents them to the user. When the user selects an image to be printed and specifies the size and number of prints, the image printing apparatus calculates and displays the fee. The image printing apparatus includes a billing unit configured to receive money and give change. Upon receiving payment from the user, the image printing apparatus prints out the image.

The image printing apparatus including the billing unit is expensive. Installing a plurality of such image printing apparatuses in the store leads to increased overall costs.

Accordingly, a system has been proposed, in which a plurality of image printing apparatuses not including a billing unit are installed and the user pays the clerk at the counter. For example, Patent Literature (PTL) 1 discloses an image printing system which includes an accepting terminal configured to accept input of an order for printing image data, a printer configured to print the image data, and a register terminal. The accepting terminal acquires image data from a recording medium brought in by the user, accepts a user's order including image data to be printed and the size and number of prints, and transfers the image data to the printer together with the order information. At the same time, the accepting terminal outputs a first receipt on which, for example, a barcode indicating the amount to be collected, order details, and order identification information are printed.

The register terminal is installed at the counter for payment. The clerk receives the first receipt from the user, performs a billing process, and passes the barcode on the first receipt over a barcode reader of the register terminal. The register terminal prints the order identification information required for receiving prints as a barcode on a second receipt and outputs it.

When the user passes the second receipt over a barcode reader of the printer, the printer reads the order identification information from the barcode on the second receipt, and prints the image data received from the accepting terminal in accordance with the order identification information.

In the conventional image printing system described above, a heavy workload is placed on clerks, because they are required to perform a billing process for every user who places a print order. When the image printing system is installed in a store, such as a large appliance store, the user who has placed a print order needs to stand in line with purchasers of other goods, such as appliances, at the counter for payment. That is, it takes time to obtain prints, and this hinders improvement in convenience.

PTL 1: Japanese Unexamined Patent Application Publication No. 2013-84043

### SUMMARY OF INVENTION

The present invention has been made in view of the conventional circumstances described above. An object of the present invention is to provide an image printing system, an image printing method, and a payment machine that reduce store costs and improve user convenience.

According to one aspect of the invention, an image printing system includes a plurality of image printing apparatuses each configured to accept a print order for printing image data and print the image data, a payment machine connected to the image printing apparatuses to be able to communicate therewith, the payment machine being configured to perform a billing process based on the print order, and a ticketing machine connected to the image printing apparatuses to be able to communicate therewith. If payment at the payment machine is selected, the image printing apparatus generates first ticket data including order details of the print order and identification information for identifying the print order, transmits the order details and the identification information to the payment machine, receives first key information for starting print processing from the payment machine that has performed the billing process, and prints the image data on the basis of the print order upon accepting input of the first key information after receiving the first key information. If payment at a counter is selected, the image printing apparatus generates second ticket data including order details of the print order and identification information for identifying the print order, transmits second key information for starting print processing to the ticketing machine, and prints the image data on the basis of the print order upon accepting input of the second key information. When the identification information included in the first ticket data is input, the payment machine identifies the order details received from the image printing apparatus on the basis of the input identification information, performs a billing process, generates third ticket data including the first key information after the billing process, and transmits the first key information to the image printing apparatus that has generated the first ticket data. The ticketing machine generates fourth ticket data including the second key information received from the image printing apparatus.

According to one aspect of the invention, after accepting selection of a method of payment of a printing fee, the image printing apparatus enters suspend mode and accepts no new print order.

According to one aspect of the invention, if input of the first key information or the second key information is not accepted within a certain period of time, the image printing apparatus resumes operation and becomes ready to accept a new print order.

According to one aspect of the invention, the second ticket data does not include the second key information.

According to one aspect of the invention, the image printing apparatus transmits the first ticket data or the second ticket data to a mobile terminal.

According to one aspect of the invention, the payment machine receives the identification information included in the first ticket data from the mobile terminal, and transmits the third ticket data to the mobile terminal.

According to one aspect of the invention, the ticketing machine transmits the fourth ticket data to the mobile terminal.

According to one aspect of the invention, the image printing apparatus issues a first ticket by printing the first ticket data on a sheet, or issues a second ticket by printing the second ticket data on a sheet, the payment machine issues a third ticket by printing the third ticket data on a sheet, and the ticketing machine issues a fourth ticket by printing the fourth ticket data on a sheet.

According to one aspect of the invention, a payment machine receives, from an image printing apparatus configured to accept a print order for printing image data and print the image data, order details of the print order and identification information for identifying the print order and performs a billing process. The payment machine includes an accepting unit configured to accept input of identification information included in ticket data generated by the image printing apparatus, a billing unit configured to perform a billing process on the basis of order details of a print order corresponding to the input identification information, a communicating unit configured to transmit, after the billing process, key information for starting print processing to the image printing apparatus, and a generating unit configured to generate ticket data including the key information.

According to one aspect of the invention, if, after receiving the order details of the print order and the identification information from the image printing apparatus, a billing process corresponding to the print order is not performed within a certain period of time, the payment machine provides notification that there is an unprocessed print order.

According to one aspect of the invention, the payment machine further includes a transmitting unit configured to transmit the ticket data generate by the generating unit to a mobile terminal. The accepting unit receives the ticket data generated by the image printing apparatus from the mobile terminal.

According to one aspect of the invention, the payment machine further includes a ticket printer configured to issue a ticket by printing the ticket data including the key information on a sheet. The accepting unit accepts input of identification information printed on a ticket issued by the image printing apparatus.

According to one aspect of the invention, an image printing method uses an image printing apparatus, a payment machine, and a ticketing machine. The image printing apparatus accepts selection of a method of payment of a printing fee after accepting a print order for printing image data, and if payment at the payment machine is selected, the image printing apparatus generates first ticket data including order details of the print order and identification information for identifying the print order, and transmits the order details and the identification information to the payment machine, whereas if payment at a counter is selected, the image printing apparatus generates second ticket data including order details of the print order and identification information for identifying the print order, and transmits second key information for starting print processing to the ticketing machine. When the identification information included in the first ticket data is input, the payment machine identifies the order details received from the image printing apparatus on the basis of the input identification information, performs a billing process, generates third ticket data including first key information for starting print processing after the billing process, and transmits the first key information to the image printing apparatus. The ticketing machine generates fourth ticket data including the second key information received from the image printing apparatus. The image printing apparatus prints the image data on the basis of the print order if accepting input of the first key information included in the third ticket data after receiving the first key information from the payment machine, or if accepting input of the second key information included in the fourth ticket data after transmitting the second key information to the ticketing machine.

According to one aspect of the invention, after accepting selection of a method of payment of a printing fee, the image printing apparatus enters suspend mode and accepts no new print order.

According to one aspect of the invention, if input of the first key information or the second key information is not accepted within a certain period of time, the image printing apparatus resumes operation and becomes ready to accept a new print order.

According to one aspect of the invention, the image printing apparatus generates the second ticket data that does not include the second key information.

According to one aspect of the invention, the image printing apparatus transmits the first ticket data or the second ticket data to a mobile terminal.

According to one aspect of the invention, the payment machine receives the identification information included in the first ticket data from the mobile terminal, and transmits the third ticket data to the mobile terminal.

According to one aspect of the invention, the ticketing machine transmits the fourth ticket data to the mobile terminal.

According to one aspect of the invention, the image printing apparatus issues a first ticket by printing the first ticket data on a sheet, or issues a second ticket by printing the second ticket data on a sheet, the payment machine issues a third ticket by printing the third ticket data on a sheet, and the ticketing machine issues a fourth ticket by printing the fourth ticket data on a sheet.

### Advantageous Effects of Invention

The present invention not only reduces costs in the store where the image printing system is installed, but also improves user convenience.

### BRIEF DESCRIPTION OF DRAWINGS

FIG. 1 is a schematic configuration diagram of an image printing system according to an embodiment of the present invention.

FIGS. 2a to 2c each illustrate a ticket issued in the image printing system according to the present embodiment.

FIG. 3 is an external view of an image printing apparatus.

FIG. 4 is a block configuration diagram of the image printing apparatus.

FIG. 5 is a block diagram of functions implemented by executing a print processing program.

FIG. 6 shows a screen displayed while the image printing apparatus is on standby waiting for payment.

FIG. 7 is an external view of a payment machine.

FIG. 8 is a block configuration diagram of the payment machine.

FIG. 9 is a block configuration diagram of a ticketing machine.

FIG. 10 is a flowchart illustrating a process performed by the image printing apparatus.

FIG. 11 is a flowchart illustrating a process performed by the payment machine.

### DESCRIPTION OF EMBODIMENTS

Embodiments of the present invention will now be described on the basis of the drawings.

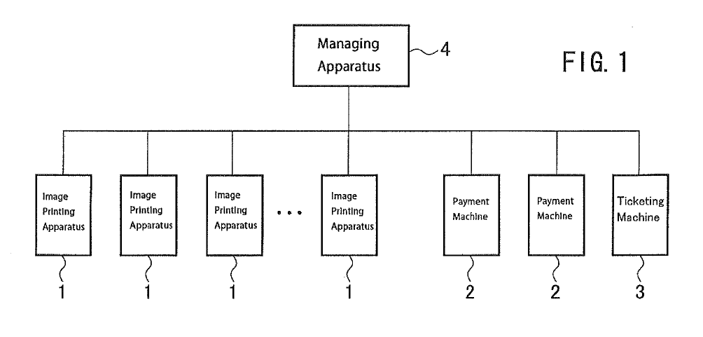

FIG. 1 is a schematic configuration diagram of an image printing system according to an embodiment of the present invention. As illustrated in FIG. 1, the image printing system includes a plurality of image printing apparatuses 1, at least one payment machine 2, a ticketing machine 3, and a managing apparatus 4. The image printing system is installed in a store or the like. The image printing apparatuses 1 and the payment machine 2 are installed in a location where users can operate them. The ticketing machine 3 is installed behind a counter where clerks are present, and it is only necessary that there be one ticketing machine 3.

The image printing apparatuses 1 each read image data from a storage medium brought in by the user, displays thumbnails on the screen, and accepts from the user a print order, including selection of an image to be printed and specification of the size and number of prints. After accepting the print order, the image printing apparatus 1 accepts selection of a method of payment for the printing. This image printing system allows selection of either “machine payment” which involves automatic payment using the payment machine 2, or “counter payment” which involves direct payment to the clerk at the counter.

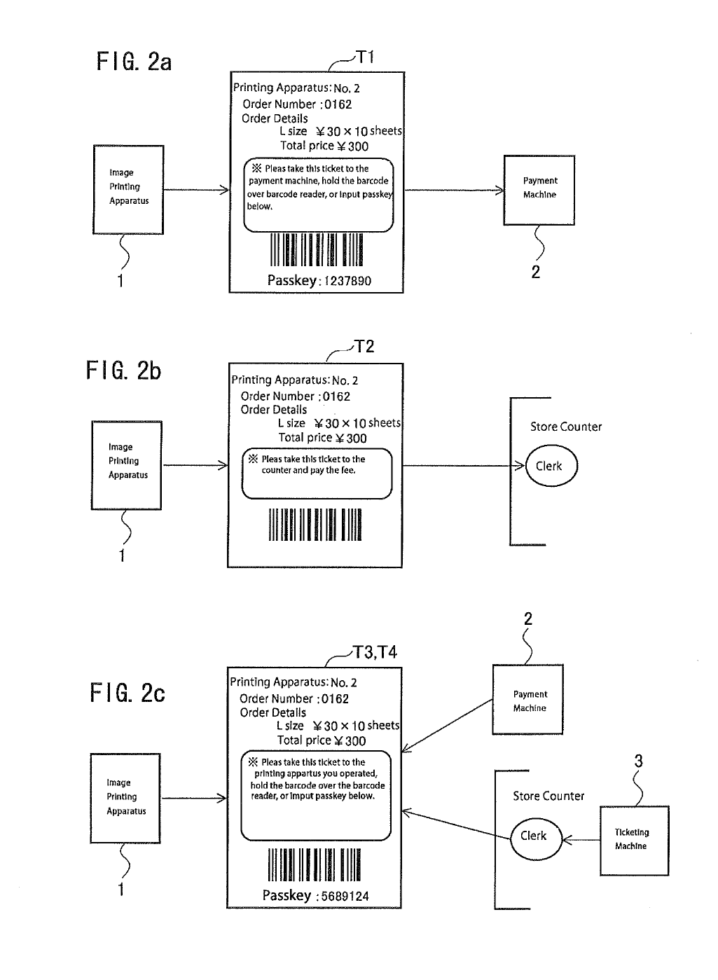

If the user selects “machine payment”, the image printing apparatus 1 issues, as illustrated in FIG. 2a, a first ticket T1 on which the order details including the breakdown of the print order and the total price, the order number for the print order, the apparatus number, and the like are printed. After issuing the first ticket T1, the image printing apparatus 1 transmits the information printed on the first ticket T1 to the payment machine 2. Besides the order number, the image printing apparatus 1 may generate a passkey (key information) for identifying the print order, print the passkey on the first ticket T1, and, at the same time, transmit the passkey to the payment machine 2. A barcode indicating the order number or passkey may be printed on the first ticket T1.

When the user takes the issued first ticket T1 to the payment machine 2 and makes the payment machine 2 read the barcode printed on the first ticket T1, the payment machine 2 identifies the user's print order among print orders received from the image printing apparatuses 1 and performs a billing process. Instead of making the payment machine 2 read the barcode, the user may manually enter the order number or passkey into the payment machine 2.

After the billing process, the payment machine 2 notifies the image printing apparatus 1, which has accepted the print order, of completion of the payment, and transmits a passkey that gives permission to perform image print processing to the image printing apparatus 1. Also, as illustrated in FIG. 2c, the payment machine 2 issues a third ticket T3 on which this passkey, the order details, the order number, and the apparatus number of the image printing apparatus 1 on which the user has placed the print order are printed. A barcode indicating the passkey may be printed on the third ticket T3.

The user takes the third ticket T3 to the image printing apparatus 1 on which the user has placed the print order, and makes the image printing apparatus 1 read the barcode printed on the third ticket T3. The image printing apparatus 1 compares the read passkey with the passkey received from the payment machine 2. If the passkeys match, the image printing apparatus 1 prints out the image on the basis of the print order. Instead of making the image printing apparatus 1 read the barcode, the user may manually enter the passkey written on the third ticket T3 into the image printing apparatus 1. After printing out the image, the image printing apparatus 1 issues a receipt.

After issuing the first ticket T1, the image printing apparatus 1 enters suspend mode and accepts no new print order until it reads the barcode on the third ticket T3 or receives manual entry of the passkey.

If the user selects “counter payment” in the selection of a method of payment, the image printing apparatus 1 issues, as illustrated in FIG. 2b, a second ticket T2 on which the order details including the breakdown of the print order and the total price, the order number for the print order, the apparatus number, and the like are printed. After issuing the second ticket T2, the image printing apparatus 1 transmits the information printed on the second ticket T2 to the ticketing machine 3. At the same time, the image printing apparatus 1 generates a passkey for starting print processing and transmits it to the ticketing machine 3. This passkey is not printed on the second ticket T2. A barcode indicating the order details may be printed on the second ticket T2.

The ticketing machine 3 installed behind the counter in the store prints the information received from the image printing apparatus 1, and issues a fourth ticket T4 such as that illustrated in FIG. 2c. A passkey printed on the fourth ticket T4 is one received from the image printing apparatus 1.

When the user takes the second ticket T2 issued by the image printing apparatus 1 to the counter and hands the second ticket T2 to the clerk, the clerk collects the fee from the user on the basis of the description on the received second ticket T2 and the fourth ticket T4 corresponding thereto. After collecting the fee, the clerk hands the fourth ticket T4 to the user.

The user takes the fourth ticket T4 received from the clerk to the image printing apparatus 1 on which the user has placed the print order, and makes the image printing apparatus 1 read a barcode printed on the fourth ticket T4. The image printing apparatus 1 compares a read passkey with the passkey the image printing apparatus 1 has transmitted to the ticketing machine 3. If the passkeys match, the image printing apparatus 1 prints out the image on the basis of the print order. Instead of making the image printing apparatus 1 read the barcode, the user may manually enter the passkey written on the fourth ticket T4 into the image printing apparatus 1. After printing out the image, the image printing apparatus 1 issues a receipt.

In the case of counter payment, as in the case of machine payment, the image printing apparatus 1 enters suspend mode after issuing the second ticket T2, and accepts no new print order until it reads the barcode on the fourth ticket T4 or receives manual entry of the passkey.

The managing apparatus 4 controls data transfer between the image printing apparatuses 1 and the payment machine 2, and controls data transfer from the image printing apparatuses 1 to the ticketing machine 3. Communication between the image printing apparatuses 1 and the payment machine 2 includes data exchange through the managing apparatus 4. Similarly, communication between the image printing apparatuses 1 and the ticketing machine 3 includes data exchange through the managing apparatus 4. The managing apparatus 4 manages order numbers to be generated for print orders, such that there is no overlap of order numbers among the image printing apparatuses 1.

In the image printing system according to the present embodiment, the image printing apparatuses 1 do not require a billing function. Since the image printing system requires installation of payment machines 2 fewer in number than image printing apparatuses 1, the overall cost of hardware can be reduced.

The user who places a print order can pay at the payment machine 2. Therefore, when the image printing system is installed in a store, such as a large appliance store, the user does not need to stand in line with purchasers of other goods, such as appliances, at the counter for payment, and can quickly pay for the printing. The user can also select counter payment as a method of payment. This allows users who are unfamiliar with automatic payment at the payment machine 2, such as elderly people, to pay the clerk at the counter. Also, if the payment machine 2 only supports credit card payment, users who do not own credit cards can pay the clerk at the counter.

Installing the payment machine 2 reduces the number of users who pay at the counter, and thus reduces clerk workload associated with collection of printing fees.

After issuing the first ticket T1 or the second ticket T2 in accordance with the method of payment selected by the user, the image printing apparatus 1 enters suspend mode and accepts no new print order until it reads a barcode on the third ticket T3 or the fourth ticket T4 (or receives manual entry of a passkey). That is, the image printing apparatus 1 is configured such that while the user is paying at the payment machine 2 or the counter, the image printing apparatus 1 is prevented from being used by other users. Therefore, after completion of the payment, the user can return to the image printing apparatus 1 that the user has used and can quickly start print processing.

As described above, the present embodiment not only reduces store costs, but also improves user convenience.

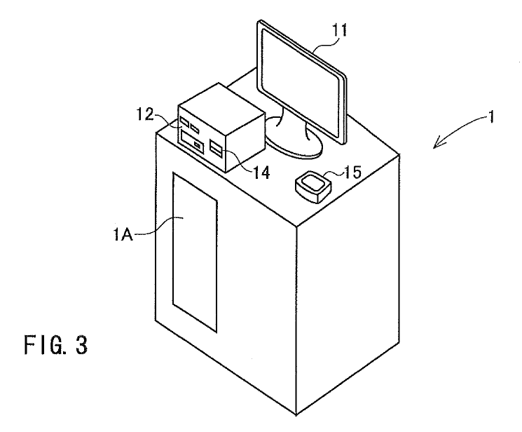

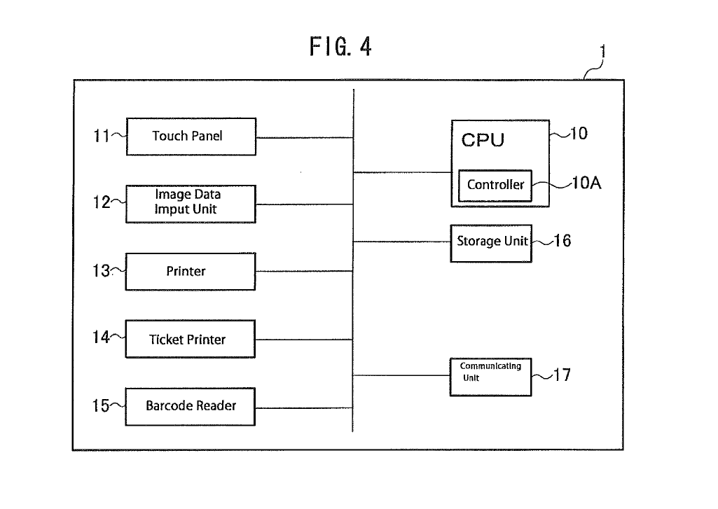

FIG. 3 is an external view of the image printing apparatus 1. FIG. 4 is a block configuration diagram of the image printing apparatus 1. The image printing apparatus 1 includes a central processing unit (CPU) 10, a touch panel (display unit, operation unit) 11, an image data input unit 12, a printer 13, a ticket printer 14, a barcode reader 15, a storage unit 16, and a communicating unit 17. These components of the image printing apparatus 1 are connected through a bus.

The touch panel 11 displays information including images, and accepts input of various instructions from the user. For example, the touch panel 11 accepts, from the user, a print order including selection of image data to be printed out and specification of the number of prints of the selected image data, selection of a method of payment, and a order number or passkey printed on the third ticket T3 issued by the payment machine 2 or on the fourth ticket T4 issued by the ticketing machine 3.

The image data input unit 12 reads image data from a storage medium storing image data captured by a digital camera or the like, and thereby accepts input of the image data. The image data input unit 12 includes data readers that support various storage media. The image data input unit 12 is capable of accepting input of image data from a mobile terminal through infrared or wireless communication.

The printer 13 is a high-resolution color printer of a dye-sublimation or inkjet type, and prints and outputs image data on the basis of order details. The printer 13 is housed in a cabinet. More than one printer 13 may be installed. As illustrated in FIG. 3, the cabinet has a transparent, opening and closing door 1A on the front side thereof. An accumulation unit (not shown) for accumulating prints printed out by the printer 13 is provided on the back side of the door 1A. Opening the door 1A allows prints accumulated in the accumulation unit to be taken out.

Upon accepting selection of a method of payment, the ticket printer 14 issues the first ticket T1 or second ticket T2 (see FIGS. 2a and 2b) on which order details and others are printed. The ticket printer 14 may output a receipt after image print processing.

The barcode reader 15 reads a barcode printed on the third ticket T3 issued by the payment machine 2, or on the fourth ticket T4 issued by the ticketing machine 3, and acquires a passkey.

The storage unit 16 stores a print processing program, a control program, and input image data. The image data is deleted after the corresponding image is printed out. The storage unit 16 includes at least one of the following types of storage media: flash memory medium, hard disk medium, MultiMediaCard micro medium, card memory (e.g., SD or XD memory), RAM, SRAM, ROM, EEPROM, PROM, and magnetic memory.

The communicating unit 17 communicates with the payment machine 2 and the ticketing machine 3 through a wired or wireless network.

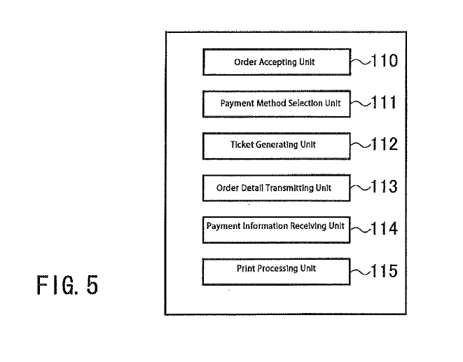

By executing the control program in the storage unit 16, the CPU 10 functions as a controller 10A that controls each component of the image printing apparatus 1. Also, by executing the print processing program, the CPU 10 implements, as illustrated in FIG. 5, an order accepting unit 110, a payment method selection unit 111, a ticket generating unit 112, an order detail transmitting unit 113, a payment information receiving unit 114, and a print processing unit 115.

The order accepting unit 110 displays image data input through the image data input unit 12 as thumbnails on the touch panel 11, and accepts a print order including selection of an image to be printed and the size and number of prints.

The payment method selection unit 111 accepts user's selection of either “machine payment” or “counter payment” as a method of payment.

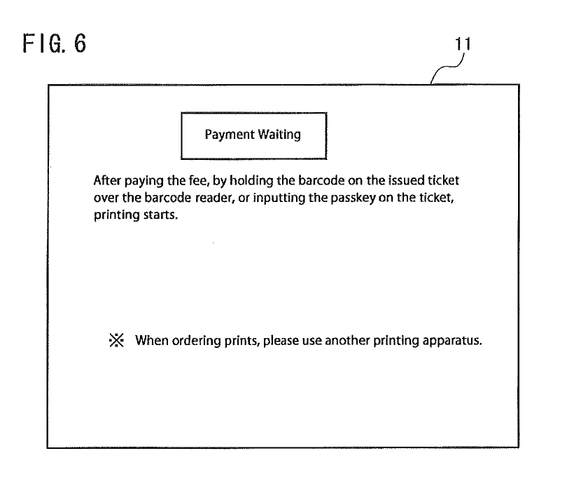

The ticket generating unit 112 generates ticket description information appropriate for the selected method of payment, and issues the first ticket T1 or the second ticket T2 from the ticket printer 14. After issuing the first ticket T1 or the second ticket T2, the image printing apparatus 1 enters suspend mode where it accepts no new print order, and displays a screen shown in FIG. 6 on the touch panel 11.

If the user selects “machine payment”, the order detail transmitting unit 113 transmits information printed on the first ticket T1 through the communicating unit 17 to the payment machine 2. If the user selects “counter payment”, the order detail transmitting unit 113 transmits information printed on the second ticket T2 and a passkey for starting print processing through the communicating unit 17 to the ticketing machine 3.

After “machine payment” is selected by the user and the first ticket T1 is issued, the payment information receiving unit 114 receives, from the payment machine 2, information indicated that payment for printing has been made. The information received from the payment machine 2 includes a passkey for starting print processing.

When “machine payment” is selected by the user and the barcode reader 15 reads a barcode on the third ticket T3 issued by the payment machine 2 (or a passkey is manually entered), the print processing unit 115 compares the read (or manually entered) passkey with the passkey the payment information receiving unit 114 has received from the payment machine 2. If the passkeys match, the print processing unit 115 starts print processing and causes the printer 13 to output prints. When “counter payment” is selected by the user and the barcode reader 15 reads a barcode on the fourth ticket T4 issued from the ticketing machine 3 (or a passkey is manually entered), the print processing unit 115 compares the read (or manually entered) passkey with the passkey the order detail transmitting unit 113 has transmitted to the ticketing machine 3. If the passkeys match, the print processing unit 115 starts print processing and causes the printer 13 to output prints.

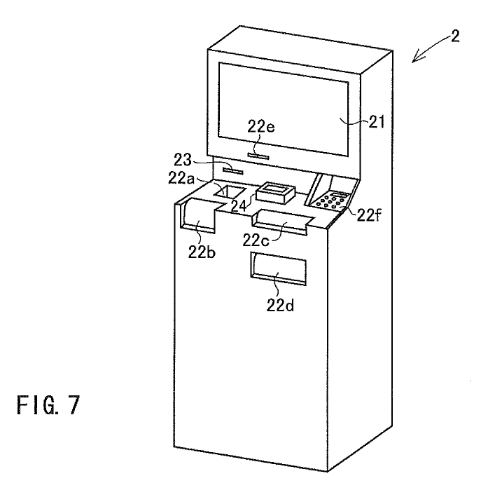

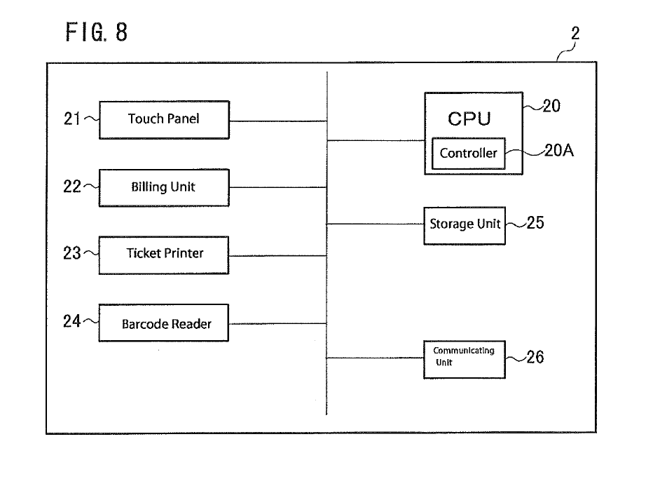

FIG. 7 is an external view of the payment machine 2, and FIG. 8 is a block configuration diagram of the payment machine 2. The payment machine 2 includes a CPU 20, a touch panel 21, a billing unit 22, a ticket printer 23, a barcode reader 24, a storage unit 25, and a communicating unit 26. These components of the payment machine 2 are connected through a bus.

As illustrated in FIG. 7, the billing unit 22 includes a coin input port 22a, a coin output port 22b, a bill input port 22c, a bill output port 22d, a card insertion slot 22e, and a numeric keypad 22f. The billing unit 22 identifies and counts money put in the coin input port 22a and the bill input port 22c, and discharges change from the coin output port 22b and the bill output port 22d. The billing unit 22 is capable of processing a credit card transaction using a credit card inserted into the card insertion slot 22e. The numeric keypad 22f accepts input of a personal identification number and the like.

The ticket printer 23 issues the third ticket T3 (see FIG. 2c) after a billing process.

The barcode reader 24 reads a barcode on the first ticket T1 issued by the image printing apparatus 1, and acquires an order number or passkey for identifying the print order. The order number or passkey may be manually entered using the touch panel 21 or the numeric keypad 22f.

The storage unit 25 stores a control program. The storage unit 25 includes at least one of the following types of storage media: flash memory medium, hard disk medium, MultiMediaCard micro medium, card memory (e.g., SD or XD memory), RAM, SRAM, ROM, EEPROM, PROM, and magnetic memory.

The communicating unit 26 communicates with the image printing apparatuses 1 through a wired or wireless network.

By executing the control program in the storage unit 25, the CPU 20 functions as a controller 20A that controls each component of the payment machine 2. The controller 20A identifies a print order from a passkey or order number entered by the user, and performs a billing process using the billing unit 22.

Order details may be transmitted from a plurality of image printing apparatuses 1 to each payment machine 2, or a plurality of image printing apparatuses 1 may transmit order details to the managing apparatus 4 and the payment machine 2 may notify the managing apparatus 4 of an entered passkey or order number to inquire the order details.

After the billing process, the controller 20A transmits, through the communicating unit 26 to the image printing apparatus 1, a notification of completion of the payment and a passkey for starting print processing, and causes the ticket printer 23 to issue the third ticket T3.

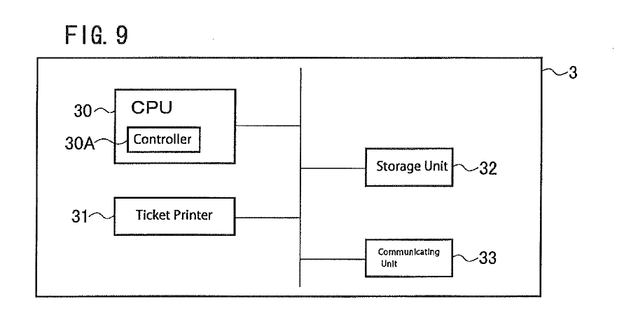

FIG. 9 is a block configuration diagram of the ticketing machine 3. The ticketing machine 3 includes a CPU 30, a ticket printer 31, a storage unit 32, and a communicating unit 33. These components of the ticketing machine 3 are connected through a bus.

The ticket printer 31 issues the fourth ticket T4 (see FIG. 2c).

The storage unit 32 stores a control program. The storage unit 32 includes at least one of the following types of storage media: flash memory medium, hard disk medium, MultiMediaCard micro medium, card memory (e.g., SD or XD memory), RAM, SRAM, ROM, EEPROM, PROM, and magnetic memory.

The communicating unit 33 communicates with the image printing apparatuses 1 through a wired or wireless network.

By executing the control program in the storage unit 32, the CPU 30 functions as a controller 30A that controls each component of the ticketing machine 3. Upon receiving order details and a passkey from the image printing apparatus 1 through the communicating unit 33, the controller 30A issues, from the ticket printer 31, the fourth ticket T4 on which the received order details and the passkey are printed.

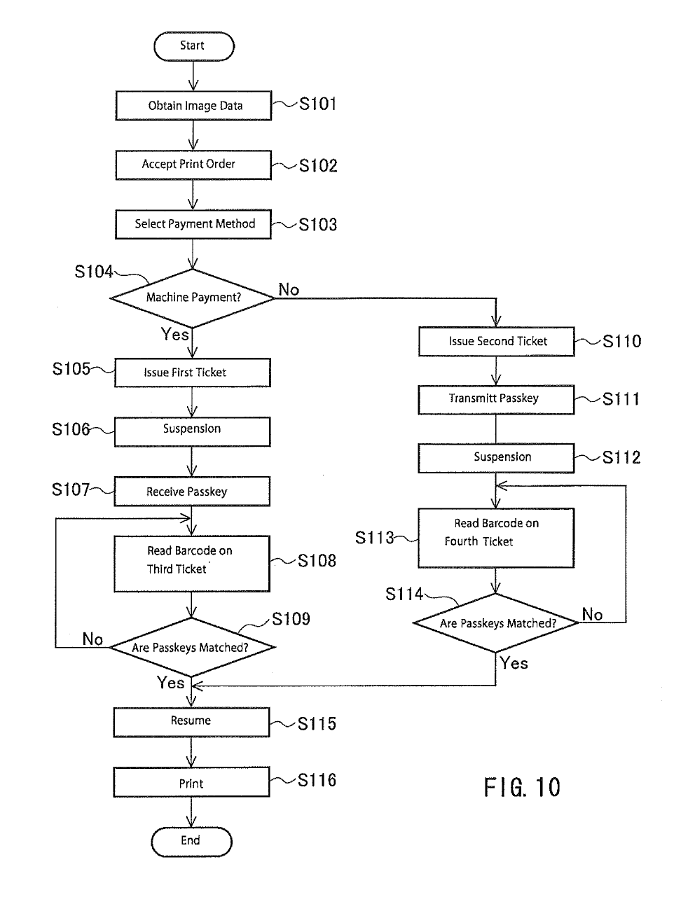

FIG. 10 is a flowchart illustrating a process performed by the image printing apparatus 1.

When image data is input through the image data input unit 12 from a storage medium brought in by the user, the touch panel 11 displays input images as thumbnails (step S101). The order accepting unit 110 accepts, through the touch panel 11, a user's print order including selection of an image to be printed and the size and number of prints (step S102).

Upon accepting the print order, the touch panel 11 displays a screen for selecting a method of payment (step S103). If the user selects machine payment (Yes in step S104), the ticket generating unit 112 issues the first ticket T1 (step S105). At the same time, the order detail transmitting unit 113 transmits information printed on the first ticket T1 to the payment machine 2 through the communicating unit 17. After issuing the first ticket T1, the image printing apparatus 1 enters suspend mode where it accepts no new print order (step S106).

When the user completes a billing process on the payment machine 2 using the first ticket T1, the payment information receiving unit 114 receives, from the payment machine 2, information indicating that payment for printing has been made (step S107). The information received from the payment machine 2 includes a passkey for starting print processing.

When the user passes the third ticket T3 issued from the payment machine 2 over the barcode reader 15, the image printing apparatus 1 acquires a passkey (step S108). If the passkey acquired by the barcode reader 15 and a passkey received in step S107 match (Yes in step S109), the image printing apparatus 1 resumes the operation (step S115), and the printer 13 outputs prints on the basis of the print order (step S116).

If the user selects counter payment (No in step S104), the ticket generating unit 112 issues the second ticket T2 (step S110). At the same time, the order detail transmitting unit 113 transmits information printed on the second ticket T2 and a passkey for starting print processing to the ticketing machine 3 through the communicating unit 17 (step S111). After issuing the second ticket T2, the image printing apparatus 1 enters suspend mode where it accepts no new print order (step S112).

The ticketing machine 3 installed behind the counter prints the information received from the image printing apparatus 1 and issues the fourth ticket T4. When the user takes the second ticket T2 to the counter and hands the second ticket T2 to the clerk, the clerk gets the fourth ticket T4 corresponding to the second ticket T2, checks the order details, and collects the fee from the user. After collecting the fee, the clerk hands the fourth ticket T4 to the user.

When the user passes the fourth ticket T4 received from the clerk over the barcode reader 15, the image printing apparatus 1 acquires a passkey (step S113). If the passkey acquired by the barcode reader 15 and the passkey transmitted in step S111 match (Yes in step S114), the image printing apparatus 1 resumes the operation (step S115), and the printer 13 outputs prints on the basis of the print order (step S116).

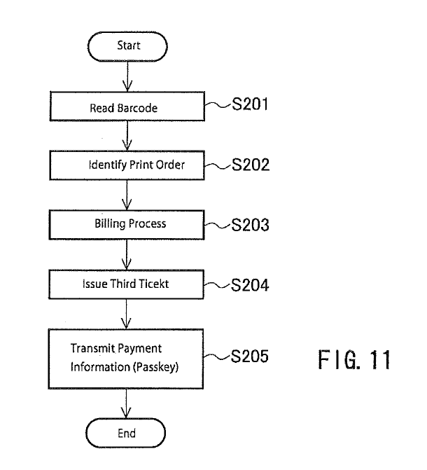

FIG. 11 is a flowchart illustrating a process performed by the payment machine 2.

When the user passes a barcode printed on the first ticket T1 issued by the image printing apparatus 1 over the barcode reader 24 (step S201), the payment machine 2 acquires an order number or passkey and identifies the user's print order (step S202).

When order details of the identified print order are displayed on the touch panel 21 and the user presses a confirmation key, the billing unit 22 performs a billing process (step S203). In the case of cash payment, the billing unit 22 identifies and counts money put in the coin input port 22a and the bill input port 22c, and discharges change from the coin output port 22b and the bill output port 22d. In the case of credit card payment, the billing unit 22 processes a credit card transaction upon insertion of a credit card into the card insertion slot 22e.

After the billing process, the ticket printer 23 issues the third ticket T3 (step S204). A notification of completion of the payment and a passkey for starting print processing are transmitted through the communicating unit 26 to the image printing apparatus 1 (step S205).

As described above, in the present embodiment, the billing function is removed from the image printing apparatus 1, and payment is processed by a few payment machines 2. This can reduce the overall hardware cost of the image printing system.

The user can pay at the payment machine 2 without standing in line at the counter. The user can also select to pay at the counter, and this provides good convenience in payment. When users pay at the payment machine 2, the workload of clerks is reduced as they do not need to collect fees.

The image printing apparatus 1 is configured such that while the user is paying at the payment machine 2 or the counter, the image printing apparatus 1 is prevented from being used by other users. Therefore, after completion of the payment, the user can return to the image printing apparatus 1 that the user has used, start print processing, and quickly obtain prints.

As described above, the present embodiment not only reduces store costs, but also improves user convenience.

In the embodiment described above, when the suspend mode associated with waiting for user's payment continues for a certain period of time (e.g., 30 minutes), the image printing apparatus 1 may resume operation and become ready to accept print orders from other users. This allows efficient operation of the image printing apparatus 1. After resumption of the operation, the order details and image data of the previous user are retained in the storage unit 16. Then, when the previous user completes the payment and returns with the third ticket T3 or the fourth ticket T4 to the image printing apparatus 1, the image printing apparatus 1 performs image print processing.

If no billing process is performed within a certain period of time (e.g., 30 minutes) after receiving the order details of the print order from the image printing apparatus 1, the payment machine 2 may provide notification that there is an unprocessed print order. For example, the payment machine 2 transmits the order details of the unprocessed print order to mobile terminals owned by clerks or a terminal in the store. A clerk who has received the notification may operate the image printing apparatus 1 in suspend mode associated with waiting for payment, so as to resume the operation and make the image printing apparatus 1 ready to accept print orders from other users. The notification that there is an unprocessed print order may be made by the managing apparatus 4, not by the payment machine 2.

In the embodiment described above, the image printing apparatus 1 enters suspend mode where it accepts no new print order while waiting for the user to pay. Alternatively, the image printing apparatus 1 may remain ready to accept print orders from other users without entering suspend mode. It is preferable in this case that after the payment, images can be printed out by any of the plurality of image printing apparatuses 1. To achieve this, for example, print orders and image data accepted by the image printing apparatuses 1 and the corresponding passkeys are managed by the managing apparatus 4. When the user who has completed the payment passes a barcode on the third ticket T3 or the fourth ticket T4 over the barcode reader 15 of one of the image printing apparatuses 1, the image printing apparatus 1 notifies the managing apparatus 4 of the read passkey, and acquires the order details and image data of the corresponding print order. The image printing apparatus 1 then prints out the image data on the basis of the acquired order details.

The image printing apparatus 1 may accept orders for prints that the printer 13 is not capable of printing. For example, when an order for 6P size (8 by 10 inch size) or 4P size (10 by 12 inch size) prints that the printer 13 is not capable of printing is accepted, the image printing apparatus 1 transmits image data to a dedicated printer installed behind the counter, and issues the second ticket T2 for payment at the counter. The user takes the second ticket T2 to the counter, pays the clerk, and receives the prints.

Although a barcode is printed on each of the first ticket T1, the second ticket T2, the third ticket T3, and the fourth ticket T4 in the embodiment described above, a two-dimensional code, instead of a barcode, may be printed thereon. A barcode may be omitted, and an order number or passkey may be manually entered.

Although the details of a print order, the order number, and the apparatus number of the image printing apparatus 1 which has accepted the order are printed on each of the first ticket T1, the second ticket T2, the third ticket T3, and the fourth ticket T4 in the embodiment described above, information to be printed is not limited to this. Additional information may be printed, or some of the information described above may be omitted.

In the embodiment described above, the ticketing machine 3 issues the fourth ticket T4 in response to receipt of information from the image printing apparatus 1. Alternatively, the ticketing machine 3 may retain the received information and issue the fourth ticket T4 after accepting input of a print instruction from the clerk. For example, the ticketing machine 3 includes a display unit, such as a liquid crystal display, on which an order number included in information received from the image printing apparatus 1 is displayed in a selectable manner. Upon receiving the second ticket T2 from the user, the clerk checks the order number written on the second ticket T2, selects the same order number on the ticketing machine 3, and gives a print instruction to the ticketing machine 3 to issue the fourth ticket T4. After collecting the fee, the clerk hands the fourth ticket T4 to the user. The ticketing machine 3 may operate in conjunction with a POS register, which reads the second ticket T2, processes the payment, and instructs the ticketing machine 3 to issue the fourth ticket T4 corresponding to the second ticket T2.

In the embodiment described above, the image printing apparatus 1 prints the order details, the order number, and the like on a sheet to issue the first ticket T1 or the second ticket T2. Alternatively, for example, when the image printing apparatus 1 accepts input of image data from a mobile terminal through wireless communication, the image printing apparatus 1 may transfer ticket data to be printed on the first ticket T1 or the second ticket T2 to the mobile terminal and skip issuing of a paper ticket. The user displays a screen of the first ticket T1 or the second ticket T2 on the display of the mobile terminal, and makes the barcode reader 24 of the payment machine 2 read a barcode or presents the screen to the clerk at the counter. Data transfer (transmission) from the image printing apparatus 1 to the mobile terminal may be made through communication using a dedicated application installed on the mobile terminal, or using an E-mail address the user has entered into the image printing apparatus 1.

In this case, after a billing process, the payment machine 2 may transfer ticket data to be printed on the third ticket T3 to the mobile terminal and skip issuing of a paper ticket. An electronic ticketing machine that receives information corresponding to the fourth ticket T4 from the image printing apparatus 1 may be installed behind the counter so that, after collecting a fee from the user, the clerk operates the electronic ticketing machine to transfer the ticket data to be printed on the fourth ticket T4 to the user's mobile terminal and skips issuing of a paper ticket. The ticketing machine 3 may have the function of the electronic ticketing machine, or the ticketing machine 3 and the electronic ticketing machine may be provided as separate units. When the dedicated application is not installed on the mobile terminal, the image printing apparatus 1 may notify the payment machine 2 or the electronic ticketing machine of the E-mail address entered by the user so that the payment machine 2 or the electronic ticketing machine transmits the ticket data to the mobile terminal using the E-mail address. By displaying a screen of the third ticket T3 or the fourth ticket T4 on the display of the mobile terminal and making the barcode reader 15 of the image printing apparatus 1 read the screen, the user can start print processing and receive prints. Instead of making the barcode reader 15 read the screen, the user may transfer the ticket data on the third ticket T3 or the fourth ticket T4 from the mobile terminal to the image printing apparatus 1 to start print processing.

While the present invention has been described in detail using specific embodiments, it is apparent to those skilled in the art that a variety of modifications can be made without departing from the spirit and scope of the present invention.

Incidentally, this application is based on a Japanese patent application (Japanese Patent Application No. 2015-013377) filed on Jan. 27, 2015, which is hereby incorporated by reference herein in its entirety.

### REFERENCE SIGNS LIST

1 Image printing apparatus

2 Payment machine

3 Ticketing machine

4 Managing apparatus

1. An image printing system comprising a plurality of image printing apparatuses each configured to accept a print order for printing image data and print the image data; a payment machine connected to the image printing apparatuses to be able to communicate therewith, the payment machine being configured to perform a billing process based on the print order; and a ticketing machine connected to the image printing apparatuses to be able to communicate therewith,
wherein if payment at the payment machine is selected, the image printing apparatus generates first ticket data including order details of the print order and identification information for identifying the print order, transmits the order details and the identification information to the payment machine, receives first key information for starting print processing from the payment machine that has performed the billing process, and prints the image data on the basis of the print order upon accepting input of the first key information after receiving the first key information;
if payment at a counter is selected, the image printing apparatus generates second ticket data including order details of the print order and identification information for identifying the print order, transmits second key information for starting print processing to the ticketing machine, and prints the image data on the basis of the print order upon accepting input of the second key information;
when the identification information included in the first ticket data is input, the payment machine identifies the order details received from the image printing apparatus on the basis of the input identification information, performs a billing process, generates third ticket data including the first key information after the billing process, and transmits the first key information to the image printing apparatus that has generated the first ticket data; and
the ticketing machine generates fourth ticket data including the second key information received from the image printing apparatus.

2. The image printing system according to claim 1, wherein after accepting selection of a method of payment of a printing fee, the image printing apparatus enters suspend mode and accepts no new print order.

3. The image printing system according to claim 2, wherein if input of the first key information or the second key information is not accepted within a certain period of time, the image printing apparatus resumes operation and becomes ready to accept a new print order.

4. The image printing system according to claim 1, wherein the second ticket data does not include the second key information.

5. The image printing system according to claim 1, wherein the image printing apparatus transmits the first ticket data or the second ticket data to a mobile terminal.

6. The image printing system according to claim 5, wherein the payment machine receives the identification information included in the first ticket data from the mobile terminal, and transmits the third ticket data to the mobile terminal.

7. The image printing system according to claim 5, wherein the ticketing machine transmits the fourth ticket data to the mobile terminal.

8. The image printing system according to claim 1, wherein the image printing apparatus issues a first ticket by printing the first ticket data on a sheet, or issues a second ticket by printing the second ticket data on a sheet;
the payment machine issues a third ticket by printing the third ticket data on a sheet; and
the ticketing machine issues a fourth ticket by printing the fourth ticket data on a sheet.

9. A payment machine that receives, from an image printing apparatus configured to accept a print order for printing image data and print the image data, order details of the print order and identification information for identifying the print order and performs a billing process, the payment machine comprising:
an accepting unit configured to accept input of identification information included in ticket data generated by the image printing apparatus;
a billing unit configured to perform a billing process on the basis of order details of a print order corresponding to the input identification information;
a communicating unit configured to transmit, after the billing process, key information for starting print processing to the image printing apparatus; and
a generating unit configured to generate ticket data including the key information.

10. The payment machine according to claim 9, wherein if, after receiving the order details of the print order and the identification information from the image printing apparatus, a billing process corresponding to the print order is not performed within a certain period of time, the payment machine provides notification that there is an unprocessed print order.

11. The payment machine according to claim 9, further comprising a transmitting unit configured to transmit the ticket data generate by the generating unit to a mobile terminal,
wherein the accepting unit receives the ticket data generated by the image printing apparatus from the mobile terminal.

12. The payment machine according to claim 9, further comprising a ticket printer configured to issue a ticket by printing the ticket data including the key information on a sheet,
wherein the accepting unit accepts input of identification information printed on a ticket issued by the image printing apparatus.

13. An image printing method comprising using an image printing apparatus, a payment machine, and a ticketing machine,
wherein the image printing apparatus accepts selection of a method of payment of a printing fee after accepting a print order for printing image data, and if payment at the payment machine is selected, the image printing apparatus generates first ticket data including order details of the print order and identification information for identifying the print order, and transmits the order details and the identification information to the payment machine, whereas if payment at a counter is selected, the image printing apparatus generates second ticket data including order details of the print order and identification information for identifying the print order, and transmits second key information for starting print processing to the ticketing machine;
when the identification information included in the first ticket data is input, the payment machine identifies the order details received from the image printing apparatus on the basis of the input identification information, performs a billing process, generates third ticket data including first key information for starting print processing after the billing process, and transmits the first key information to the image printing apparatus;
the ticketing machine generates fourth ticket data including the second key information received from the image printing apparatus; and
the image printing apparatus prints the image data on the basis of the print order if accepting input of the first key information included in the third ticket data after receiving the first key information from the payment machine, or if accepting input of the second key information included in the fourth ticket data after transmitting the second key information to the ticketing machine.

14. The image printing method according to claim 13, wherein after accepting selection of a method of payment of a printing fee, the image printing apparatus enters suspend mode and accepts no new print order.

15. The image printing method according to claim 14, wherein if input of the first key information or the second key information is not accepted within a certain period of time, the image printing apparatus resumes operation and becomes ready to accept a new print order.

16. The image printing method according to claim 13, wherein the image printing apparatus generates the second ticket data that does not include the second key information.

17. The image printing method according to claim 13, wherein the image printing apparatus transmits the first ticket data or the second ticket data to a mobile terminal.

18. The image printing method according to claim 17, wherein the payment machine receives the identification information included in the first ticket data from the mobile terminal, and transmits the third ticket data to the mobile terminal.

19. The image printing method according to claim 17, wherein the ticketing machine transmits the fourth ticket data to the mobile terminal.

20. The image printing method according to claim 13, wherein the image printing apparatus issues a first ticket by printing the first ticket data on a sheet, or issues a second ticket by printing the second ticket data on a sheet;
the payment machine issues a third ticket by printing the third ticket data on a sheet; and
the ticketing machine issues a fourth ticket by printing the fourth ticket data on a sheet.
